(19) United States
(12) Patent Application Publication
(10) Pub. No.: US 2014/0012670 A1
(43) Pub. Date: Jan. 9, 2014

(54) SYSTEM AND METHOD FOR ACQUIRING DOMAIN VISITORS ON A PARKING SERVICE AND REDIRECTING TO OPTIMAL ADVERTISERS

(71) Applicants: Nader Mohamed Hashem, Burbank, CA (US); Aaron Matthew Schiff, Los Angeles, CA (US); Matthew William Boatman, Los Angeles, CA (US)

(72) Inventors: Nader Mohamed Hashem, Burbank, CA (US); Aaron Matthew Schiff, Los Angeles, CA (US); Matthew William Boatman, Los Angeles, CA (US)

(73) Assignee: ADRENALADS LLC, Santa Monica, CA (US)

(21) Appl. No.: 13/541,767

(22) Filed: Jul. 5, 2012

(51) Int. Cl. G06Q 30/02

(52) U.S. Cl. 705/14.54; 705/14.71

(57) ABSTRACT

A system and method for acquiring domain visitor on a parking service and redirecting the visitor to two or more optimal advertisers is disclosed. The system comprises a processor, and a partner module comprising a first set of software instructions executing on the processor, wherein said first set of instructions are configured to determine a computed bid to acquire a domain visitor for a domain at a rate of profitability. The first set of instructions are further configured to break down the domain into a keyword cloud, and to select at least one of said advertisers based on the computed bid and the keyword cloud. The first set of instructions are further configured to redirect the visitor to a uniform resource locator for the selected advertiser.

### BACKGROUND OF THE INVENTION

The present invention generally relates to domain parking advertising system and method. More specifically, the invention relates to a system and method for acquiring domain visitors on a domain parking service and redirecting to optimal advertisers.

There are currently domain parking services which offer owners of domain names a domain parking page that may be displayed while a custom website is in development. The domain parking page may be a simple, generic page with a message indicating that the website is in development. During this development period, a person accessing the domain name is presented with the domain parking page instead of a dead page which would cause the display of an error message. The display of the domain parking page thus allows the person accessing the domain name to anticipate the creation of a custom website, and even create a “buzz” of the up-and-coming site.

Domain parking pages may also provide additional information and advertisements in addition to any generic message about an up-and-coming site. The information and advertisements displayed on the parking page, however, may be irrelevant and of no interest to the accessing person. There is, however, a desire to display information and advertisements that are relevant to a person accessing the parking page because the more relevant the information and advertisements, the more likely the user will interact with the displayed information. In the world of web-advertising, user interactions translate directly to revenues.

Still further, there is a desire to foster more efficient web traffic acquisition, bidding for such traffic, advertising targeting, and response. These and other objectives are provided by the system and methods described herein.

### SUMMARY OF THE INVENTION

According to one preferred embodiment, a system is disclosed for acquiring domain visitor on parking service and redirecting to two or more optimal advertisers, comprising a processor; a partner module comprising a first set of software instructions executing on the processor, said first set of instructions configured to determine a computed bid to acquire a domain visitor for a domain at a rate of profitability, the first set of instructions further configured break down the domain into a keyword cloud, the first set of software instructions further configured to select at least one of said advertisers based on the computed bid and the keyword cloud, and said first set of instructions further configured to redirect the visitor to a uniform resource locator for the selected advertiser.

According to another preferred embodiment, a method is disclosed for computing a baseline bid in a system for acquiring domain visitors on a parking service and redirecting to two or more optimal advertisers, comprising receiving a bid from each of one or more of the two or more advertisers for one or more redirects won for redirection to the advertisers' web sites, calculating a win percentage by dividing a number of redirects won by received bids; and computing the baseline bid based on the win percentage.

According to yet another preferred embodiment, a method is disclosed for targeting web advertisers, comprising creating a search string from a domain entered by a web visitor with the top-level domain removed; generating a keyword frequency set by crawling top results of a search performed in a search engine using the search string; comparing the keyword frequency set to keywords of one or more advertising campaigns of one or more advertisers; and selecting 0 or more of the advertising campaigns based on the step of comparing.

According to yet another preferred embodiment, a method is disclosed for targeting web advertisers, comprising creating a domain string from a domain entered by a web visitor with the top-level domain removed; creating one or more component strings of the domain string by splitting the domain string into one or more words; generating a keyword frequency set by crawling top results of a search performed in a search engine using each of the component strings; comparing the keyword frequency set to keywords of ad information for one or more advertising campaigns of one or more advertisers; and selecting 0 or more of the advertising campaigns based on the step of comparing.

### BRIEF DESCRIPTION OF THE DRAWINGS

FIG. 1 is a flow diagram that presents an overview of one embodiment of an acquisition and redirection system;

FIG. 2 is a flow diagram that illustrates the steps performed for traffic acquisition according to the embodiment of FIG. 1;

FIG. 3 is a flow diagram illustrates the steps performed by a bidding engine according to the embodiment of FIG. 1;

FIG. 4 is a flow diagram that illustrates the steps performed for direct advertiser targeting according to the embodiment of FIG. 2; and

FIG. 5 is a flow diagram that illustrates the steps performed to process feed advertisers according to the embodiment of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

### Overview

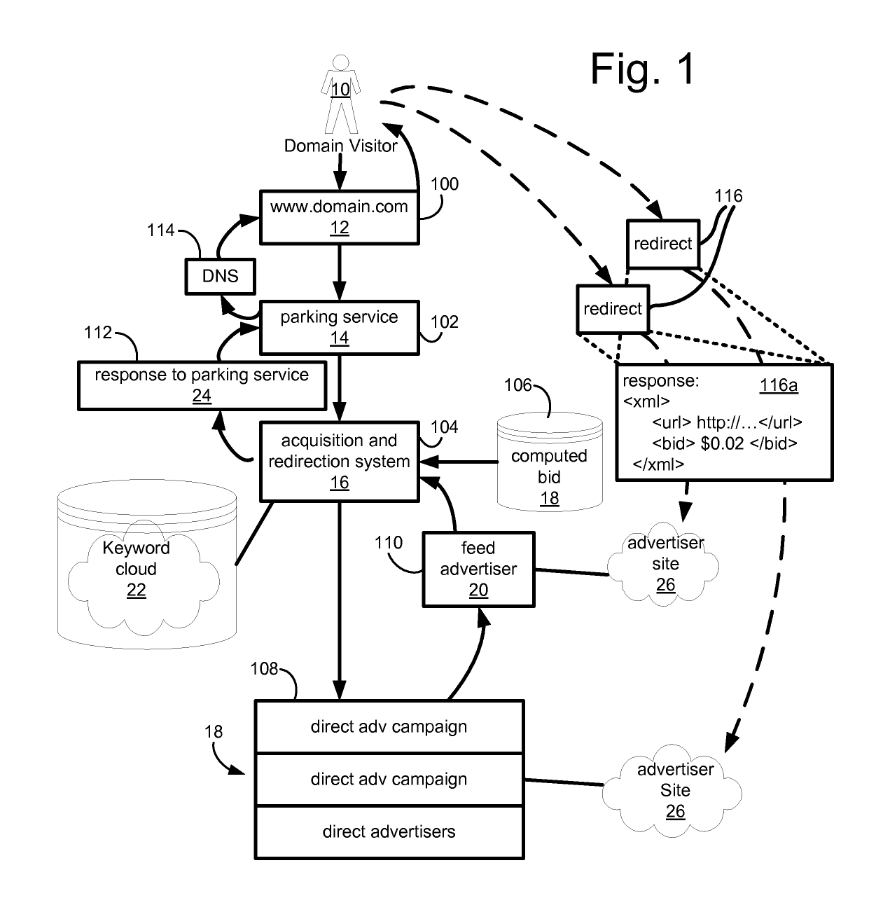

Broadly, embodiments of the present invention generally provide a system and method for acquiring domain visitors on a domain parking service and redirecting to optimal advertisers. With reference to FIG. 1, a flow diagram presents an overview of one embodiment of the system. In step 100, a domain visitor 10 may use an electronic device, by way of example, and not by way of limitation, a desktop computer, mobile phone, or the like, and may navigate the world-wide-web by visiting a domain 12 in a web browser. This domain 12 may be parked by a domain parking service 14, which typically monetizes visitors by showing ads.

In step 104, the domain parking service 14 has a method of monetization where it can redirect the visitor to a partner, by asking the partner how much they are willing to pay and redirecting them if they feel the amount is sufficiently high.

In step 106, the acquisition and redirection system 16 acts as one of these partners and participates in this auction by determining the most efficient price or computed bid 18 to acquire the visitor at the desired rate of profitability, based on the domain, visitor characteristics, and applicable advertisers as explained below in more detail.

The acquisition and redirection system 16 has a set of advertisers which are accessed in steps 108 and 110. There are two types of advertisers, direct advertisers 18 and feed advertisers 20.

The acquisition and redirection system 16 breaks down the domain 12 into a keyword cloud 22 of relevant keywords to the domain 12. This keyword cloud 22 is used to find a relevant direct advertiser 18 or feed advertiser 20. Once an advertiser 18 or 20 is selected, in step 112, the acquisition and redirection system 16 sends a response 24 to the parking service 14 with the selected advertiser's destination uniform resource locator (URL) and the computed bid 18.

Should this bid win, in step 114, the parking service redirects the visitor to the domain 12 of the acquisition and redirection system 16, which in turn redirects the visitor to the website 26 of the selected advertiser 18 or 20.

### Traffic Acquisition

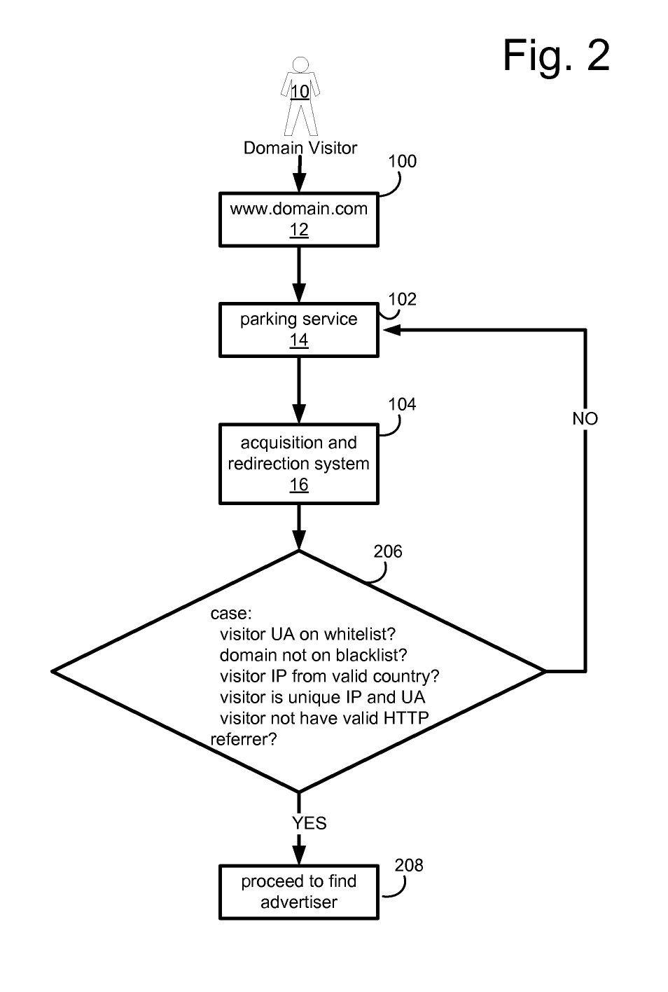

With reference to FIG. 2, a flow diagram illustrates the steps performed for traffic acquisition according to the embodiment of FIG. 1. As described in steps 100-104 of FIG. 1, a visitor 10 uses his/her browser to navigate to a domain 12 parked by a domain parking service 14.

At the point of the visit, prior to any page load, in step 104, the parking service 16 requests bids from partners, including the acquisition and redirection system 16 itself, providing various visitor information such as domain visited, user agent, IP address and the like. In one embodiment, this information is retrieved by issuing an HTTP request to the acquisition and redirection system 16.

In step 206, the acquisition and redirection system 16 validates the potential visitor 10 using a series of quality analysis metrics. These are, by way of example, and not by way of limitation:
a. Does the visitor's user agent exactly match a string from the a user agent whitelist? If not, reject bidding for the visitor, and processing moves back to step 102.
b. Otherwise, does the visitor's domain exactly match a domain on the a domain blacklist? If so, reject bidding for the visitor, and processing moves back to step 102.
c. Otherwise, does the visitor's IP originate from a country that has an applicable advertiser? If not, reject bidding for the visitor, and processing moves back to step 102.
d. Otherwise, has this visitor been seen before, by proxy of winning a previous redirect with the same IP and user agent combination? If so, reject bidding for the visitor and, processing moves back to step 102.
e. Otherwise, does the visitor's HTTP referrer match a substring of the referrer blacklist? If so, reject bidding for the visitor, and processing moves back to step 102.

Should the visitor be validated in step 206, then processing proceeds to step 208 to find the most applicable advertiser as described in the Advertiser Targeting section below, and the optimal bid is computed to win the visitor as profitably as possible as described in the Bidding Engine section below.

### Bidding Engine

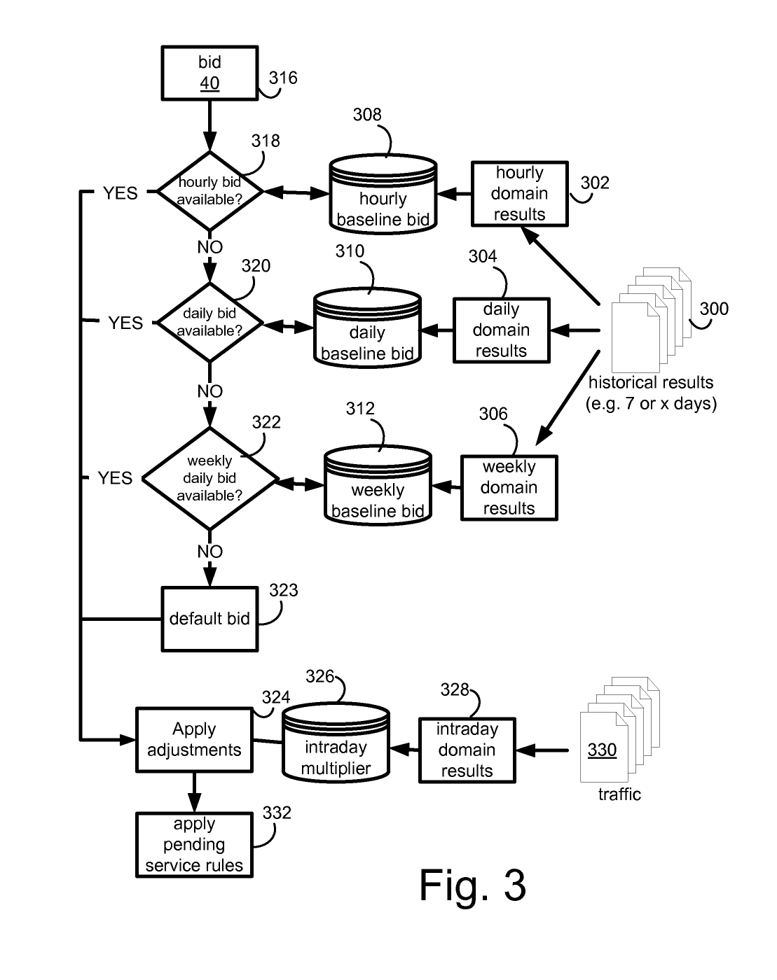

With reference to FIG. 3, a flow diagram illustrates the steps performed by a bidding engine according to one embodiment. In step 300, data input is collected, such as total requests seen from the parking services, the average bid for those requests, and redirects won by the acquisition and redirection system 16 to be analyzed as a daily batch process. By way of example, and not by way of limitation, this data may be analyzed over a period of the past seven days.

When a bid 40 is attempted, step 316, the system will first select a baseline bid from the most granular time unit possible. In this embodiment, the system checks for whether an hourly baseline bid has been calculated, step 318. If so, this hourly bid is selected as the current baseline bid, step 308. If not, the system checks for whether a daily baseline bid has been calculated, step 320. If so, this daily bid is selected as the current baseline bid, step 310. If not, the system checks for whether a weekly baseline bid has been calculated, step 322. If so, this weekly bid is selected as the current baseline bid, step 312. If not, then a global default baseline bid is selected, step 323.

In one embodiment, the analysis may be grouped by each domain, summing the requests seen and redirects won for hourly, step 302, daily, step 304, and weekly, step 306, time units. In steps 302, steps 302, 304 and 306, a winning percentage for each time unit is calculated by dividing redirects won by requests submitted.

In steps 308, 310 and 312, a baseline bid is calculated based on that win percentage. By way of example, the baseline may be computed as follows:
a. If the winning percentage for that time unit is below a specified threshold, then the baseline bid is calculated by taking the average bid and suppressing it with a multiplier below 1.
b. If the winning percentage for that time unit is above a specified threshold, then a new baseline bid is calculated by taking the average bid and increasing it with a multiplier above 1.
c. Any parking-service rules may be applied, as some parking services have absolute minimum bids where they will reject any bid under this amount, so should the computed bid be below this amount, it will be raised to this amount.

In step 324, a modifier to the baseline bid, known as the intraday bidding adjustment, is then applied. This bidding adjustment is similar to steps 300-312, where data input is collected and then grouped by time unit. However the time unit for the intraday bidding adjustment is much smaller than even an hourly computation, in one embodiment, being calculated every 10 minutes. Also unlike steps 300-312, the calculated result is not a defined monetary value, but a value to be used as a multiplier. By way of example and not by way of limitation, the following steps are performed in step 326:
a. If the winning percentage during the current time period is below a specified threshold, the intraday adjustment is set to a value greater than 1. If a previously computed intraday adjustment already exists from a previous time period and is already greater than 1 (implying that this adjustment was not sufficient to win the desired percentage of auctions), that adjustment is increased. If a previously computed intraday adjustment already exists from a previous time period and is lower than one, the multiplier is set to exactly 1.
b. If the winning percentage during the current time period is above a specified threshold, the intraday adjustment is set to a value less than 1. If a previously computed intraday adjustment already exists from a previous time period and is already less than 1 (implying that this adjustment was not sufficient to stop winning the desired percentage of auctions), that adjustment is decreased. If a previously computed intraday adjustment already exists from a previous time period and is greater than one, the multiplier is set to exactly 1.
c. If the winning percentage for that time unit is above a specified threshold, then a new baseline bid is calculated by taking the average bid and increasing it with a multiplier above 1.

Thus the value of the baseline bid is modified by the intraday bidding adjustment, step 328, which is typically a multiplier. Because bidding market conditions can shift in-between computations of the baseline bid, the intraday bidding adjustment is an attempt to compensate for such a shift. In the event the baseline bid is insufficiently high enough to win the desired amount of traffic 330, or conversely, insufficiently low enough to win the desired amount of traffic at the price desired, the intraday adjustment may increase/reduce the baseline bid by a percentage that should allow for more optimal traffic acquisition.

Global bidding rules may then be applied, step 332, which are defined as concrete bid values that the bid must be above or below. For example, the parking service may supply the minimum winning bid. In the event the baseline bid multiplied by the intraday bidding adjustment is less than the minimum winning bid, then the system may raise the bid to the minimum winning bid. In yet another example, the selected advertiser may have an expected maximum revenue (the amount of revenue expected to be paid by the advertiser). In the event the bid is above the expected maximum revenue, the bid would be reduced to exactly the expected maximum revenue.

### Advertiser Targeting

In one embodiment, there may be two layers of advertiser targeting, direct advertisers and feed advertisers.
a. Direct advertisers have specified campaigns set up with the system, for which they have specified a destination URL and a desired price to pay per visitor. The advertiser has also associated a set of keywords they feel is most relevant to the visitor's intent.
b. Feed advertisers have their advertiser set which is accessible via an application program or partner interface (API). The system may query the feed advertiser as specified by their API, where the feed advertiser will return a list of ads for their advertisers and an amount they are willing to pay for a visitor to that advertiser at that point in time.

In one embodiment, the system may find the most relevant direct advertiser for the domain visitor. Upon finding one or not finding one, the system may request advertiser links from all available feed advertisers. Of this set, the highest paying advertiser may be selected, and their expected revenue may use as a ceiling for the bid the bid calculated by the bidding engine.

### Advertiser Targeting—Direct

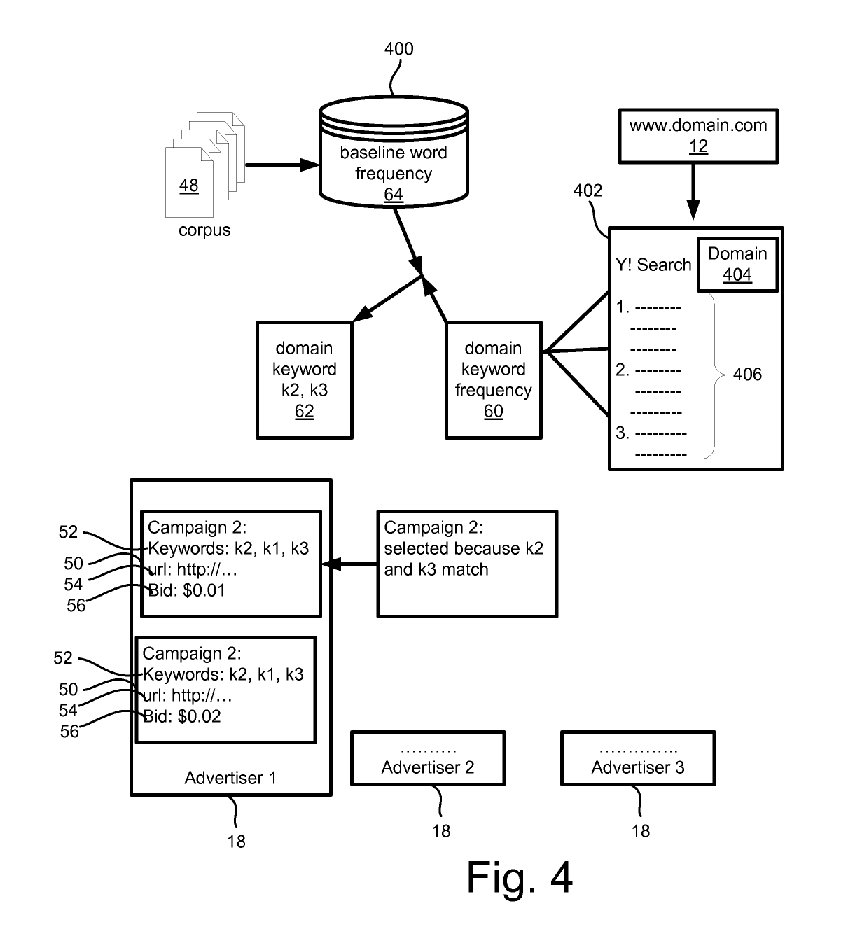

With reference to FIG. 4, a flow diagram illustrates the steps performed for direct advertiser targeting according to one embodiment. For direct advertisers, the advertiser has specified campaigns 50 that are a combination of related keywords 52, a desired price per redirect 54, and a destination URL 56.

In one embodiment, the system may generate a set of relevant keywords 62 for the domain 12 of the visitor 10. In step 400 a baseline word frequency set 64 may be established by preemptively analyzing a corpus 48 of common text (by way of example, and not by way of limitation, all the entries in a dictionary such as Wikipedia), and determining word frequency counts relative to each other.

For the domain 12 in question, a domain keyword frequency set 60 is generated by crawling the top results of a search engine 402 where the search query is composed with the top-level domain removed 404 (e.g. the search string of yourdomain.com is yourdomain). The word frequency of the results 406 are calculated.

The domain keyword frequency 60 is compared to the baseline word frequency 64. The top outliers in the domain keyword frequency set 60 are then associated as domain keywords 62 for that domain 12.

In step 404, the domain keywords 62 are then compared to the keywords associated with every advertiser campaign 18. The advertiser campaign 18 with the most matches in the advertiser campaign keyword set 52 is selected as the most relevant advertiser 18.

It is possible that no advertiser campaign 18 has a keyword set 52 that matches the domain keyword set 60, in which case no advertiser 18 is selected.

### Advertiser Targeting—Feed

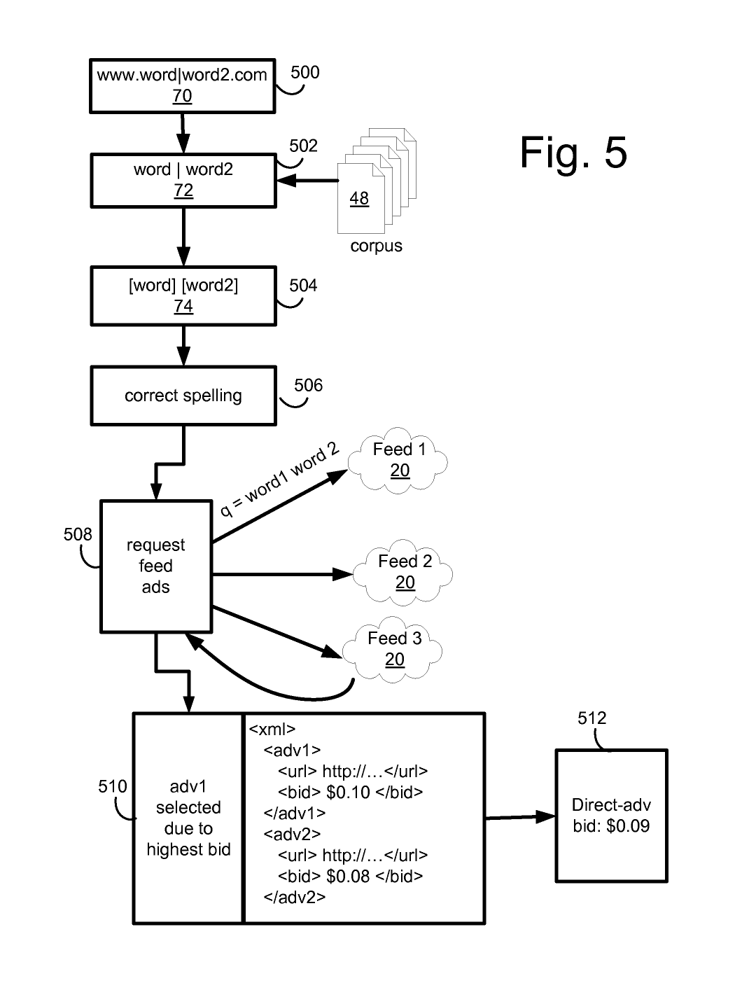

With reference to FIG. 5, a flow diagram illustrates the steps performed to process feed advertisers 16. In step 500, for feed advertisers 16, a relevant query may be determined from the visitor's domain 70. This is used to generate the domain feed keyword 72.

To generate the domain feed keyword 72, in step 500, the domain is converted into a string with the top-level domain removed. (e.g. the search string of yourdomain.com is yourdomain). In step 502, a baseline word frequency set may be established by preemptively analyzing a corpus of common text (e.g. all the entries in wikipedia.org) and determining word frequency counts relative to each other. In step 504, the domain is split into component words, if applicable, by comparing it against the baseline word frequency, which may be performed as described with respect to FIG. 4.

In step 506, the component words are corrected for any misspellings using any standard commercially available spell-check software.

In step 508, the domain feed keyword 72 may be then used in the request to all the feed advertisers 20 along with any other visitor information those advertisers require. One embodiment, by way of example and not by way of limitation, uses an HTTP GET request to make the request to the feed advertisers 20.

The feed advertisers 20 may respond with their relevant advertising set and the amount that will be paid for redirecting the visitor 10. In step 510, the system may select the advertiser 20 in the advertiser set that will pay the highest amount.

In step 510, this amount may be compared against the selected direct advertiser 18, if any, and the feed advertiser 20 will be selected as the advertiser if the amount exceeds the expected amount from the direct advertiser 18.

### Response

With reference back to FIG. 1, when the relevant advertiser is selected and the optimal bid is computed, the system may respond to the parking service 14 with the destination URL specified by the advertiser 18 or 20 and may bid the computed amount. In one embodiment, the system responds by packaging this information as an XML response 116a.

Should the bid be accepted, the parking service 14 may redirect the domain visitor 10 to the acquisition and redirection system 16, which in turn may redirect to the selected advertiser 18 or 20, and the advertiser 18 or 20 may be charged.

It should be understood, of course, that the foregoing relates to exemplary embodiments of the invention and that modifications may be made without departing from the spirit and scope of the invention as set forth in the following claims.

1. A system for acquiring a domain visitor on a parking service and redirecting to two or more optimal advertisers, comprising:
a processor;
a partner module comprising a first set of software instructions executing on the processor, said first set of instructions configured to determine a computed bid to acquire a domain visitor for a domain at a rate of profitability, the first set of instructions further configured to break down the domain into a keyword cloud;
the first set of software instructions further configured to select at least one of said advertisers based on the computed bid and the keyword cloud; and
said first set of instructions further configured to redirect the visitor to a uniform resource locator for the selected advertiser.

2. The system of claim 1, wherein said two or more advertisers comprise direct advertisers and feed advertisers.

3. The system of claim 1, wherein the first set of software instructions are configured to compute a bid for each advertiser.

4. The system of claim 3, wherein each computed bid comprises a bid selected from the group consisting of: an hourly bid, a daily bid, and a weekly bid.

5. A method for computing a baseline bid in a system for acquiring domain visitors on a parking service and redirecting to two or more optimal advertisers, comprising:
receiving a bid from each of one or more of the two or more advertisers for one or more redirects won for redirection to the advertisers' web sites;
calculating a win percentage by dividing a number of redirects won by received bids; and
computing the baseline bid based on the win percentage.

6. The method of claim 5, wherein the step of computing the bid based on the win percentage comprises:
if the win percentage is below a specified threshold, then the baseline bid is calculated by taking an average bid of all bids and suppressing it with a multiplier below 1; and
if the win percentage is above a specified threshold, then a the baseline bid is calculated by taking the average bid and increasing it with a multiplier above 1.

7. The method of claim 5, further comprising raising all received bids that are below the baseline bid to at least the baseline bid.

8. The method of claim 6, further comprising applying an intraday adjustment to the baseline bid, comprising:
if the win percentage during the current time period is below a specified threshold, the intraday adjustment is set to a value greater than 1; if a previously computed intraday adjustment already exists from a previous calculation and is already greater than 1, the previously computed intraday adjustment is increased; if a previously computed intraday adjustment already exists from a previous time period and is lower than 1, the intraday adjustment is set to exactly 1;
otherwise, if the winning percentage during the current time period is above a specified threshold, the intraday adjustment is set to a value less than 1; if a previously computed intraday adjustment already exists from a previous calculation and is already less than 1, previously computed intraday adjustment is decreased; if a previously computed intraday adjustment already exists from a previous time period and is greater than one, the multiplier is set to exactly 1;
if the winning percentage is above a specified threshold, then a new baseline bid is calculated by taking the average bid and increasing it with a multiplier above 1

9. A method for targeting web advertisers, comprising:
creating a search string from a domain entered by a web visitor with the top-level domain removed;
generating a keyword frequency set by crawling top results of a search performed in a search engine using the search string;
comparing the keyword frequency set to keywords of one or more advertising campaigns of one or more advertisers; and
selecting 0 or more of the advertising campaigns based on the step of comparing.

10. A method for targeting web advertisers, comprising:
creating a domain string from a domain entered by a web visitor with the top-level domain removed;
creating one or more component strings of the domain string by splitting the domain string into one or more words;
generating a keyword frequency set by crawling top results of a search performed in a search engine using each of the component strings;
comparing the keyword frequency set to keywords of ad information for one or more advertising campaigns of one or more advertisers; and
selecting 0 or more of the advertising campaigns based on the step of comparing.
